(19) United States
(12) Patent Application Publication
(10) Pub. No.: US 2016/0140136 A1
(43) Pub. Date: May 19, 2016

(54) Search Recommendation Method and Apparatus

(71) Applicant: BAIDU ONLINE NETWORK TECHNOLOGY (BEIJING) CO., LTD., Beijing (CN)

(72) Inventors: Jizhou HUANG, Beijing (CN); Deguo XIA, Beijing (CN); Minghua ZHAO, Beijing (CN); Ying LI, Beijing (CN); Haifeng WANG, Beijing (CN)

(21) Appl. No.: 14/899,730

(22) PCT Filed: Oct. 27, 2014
(86) PCT No.: PCT/CN2014/089587

§ 371 Date: Dec. 18, 2015

(30) Foreign Application Priority Data
Mar. 17, 2014 (CN) 201410099502.4

(51) Int. Cl. G06F 17/30

(52) U.S. Cl. CPC G06F 17/3097; G06F 17/30988; G06F 17/3089; G06F 17/30867; G06F 17/30247

(57) ABSTRACT

Provided are a search recommendation method and a search recommendation apparatus, the method comprising: receiving a search term; obtaining a plurality of search results related to the search term, and further obtaining at least one first recommendation result related to the search term; obtaining first relationship information between the search term and the at least one first recommendation result; and providing a search page, in which the search page comprises a first display section and a second display section, the first display section displaying the plurality of search results, and the second display section displaying the at least one first recommendation result and the first relationship information.

### CROSS-REFERENCE TO RELATED APPLICATION

This application claims priority to Chinese Patent Application Serial No. 201410099502.4, titled “Search Recommendation Method and Apparatus” filed by Baidu Online Network Technology (Beijing) Co., Ltd on Mar. 17, 2014.

### FIELD

Embodiments of the present invention generally relate to a field of computer networking technology, and more particularly to a search recommendation method and a search recommendation apparatus.

### BACKGROUND

With the rapid development of the Internet and the increase of webpage information, the demand on a search function of a search engine grows constantly. When search information is input, the search engine may provide a recommendation result related to the current search information, apart from a search result. For example, when a user searches with “Jay Chou”, the search engine will recommend “Teresa Teng,” “Mayday,” “Jolin Tsai,” etc. However, it is hard for a user without any relevant background information to know why these recommendation results are provided, and thus it is impossible to obtain accurate information according to the recommendation results and to recommend the user a useful search result, which degrades the user experience.

### SUMMARY

Embodiments of the present invention seek to solve the above technical problems to at least some extent.

Accordingly, a first objective of the present invention is to provide a search recommendation method which is able to provide the user with relationship between the recommended content and the user requirement quickly and explicitly, along with more explicit reasons for recommendation, so as to stimulate the user's interest in the recommendation result and increase the attention and the click-through rate.

A second objective of the present invention is to provide a search recommendation apparatus.

A third objective of the present invention is to provide a storage medium.

In order to achieve above objectives, embodiments of a first aspect of the present invention provide a search recommendation method. The search recommendation method includes: receiving a search term; obtaining a plurality of search results related to the search term, and further obtaining at least one first recommendation result related to the search term; obtaining first relationship information between the search term and the at least one first recommendation result; and providing a search page, in which the search page includes a first display section and a second display section, the first display section displaying the plurality of search results, and the second display section displaying the at least one first recommendation result and the first relationship information.

By obtaining the relationship information between the search term and the recommendation result, and displaying the search result, the recommendation result, and the relationship between the recommendation result and the search term, the search recommendation method according to embodiments of the present invention can provide the user with relationship between the recommended content and the user requirement quickly and explicitly, along with more explicit reasons for recommendation, so as to stimulate the user's interest in the recommendation result and increase the attention and the click-through rate.

Embodiments of a second aspect of the present invention provide a search recommendation apparatus. The search recommendation apparatus includes: a receiving module configured to receive a search term; a first obtaining module configured to obtain a plurality of search results related to the search term, and to further obtain at least one first recommendation result related to the search term; a second obtaining module configured to obtain first relationship information between the search term and the at least one first recommendation result; and a providing module configured to provide a search page, in which the search page includes a first display section and a second display section, the first display section displaying the plurality of search results, and the second display section displaying the at least one first recommendation result and the first relationship information.

By obtaining the relationship information between the search term and the recommendation result, and displaying the search result, the recommendation result, and the relationship between the recommendation result and the search term, the search recommendation apparatus according to embodiments of the present invention can provide the user with relationship between the recommended content and the user requirement quickly and explicitly, along with more explicit reasons for recommendation, so as to stimulate the user's interest in the recommendation result and increase the attention and the click-through rate.

Embodiments of a third aspect of the present invention provide a storage medium for storing an application program which is configured to execute the search recommendation method according to the embodiments of the first aspect of the present invention.

Additional aspects and advantages of embodiments of the present invention will be given in part in the following descriptions, become apparent in part from the following descriptions, or be learned from the practice of the embodiments of the present invention.

### BRIEF DESCRIPTION OF THE DRAWINGS

These and other aspects and advantages of embodiments of the present invention will become apparent and more readily appreciated from the following descriptions made with reference to the drawings, in which:

FIG. 1 is a flow chart of a search recommendation method according to an embodiment of the present invention.

FIG. 2 is a flow chart of a search recommendation method according to an embodiment of the present invention.

FIGS. 3a, 3b and 3c are schematic diagrams of a second display section according to an embodiment of the present invention.

FIG. 4 is a block diagram of a search recommendation apparatus according to an embodiment of the present invention.

FIG. 5 is a block diagram of a search recommendation apparatus according to another embodiment of the present invention.

### DETAILED DESCRIPTION

Embodiments of the present invention will be described in detail and examples of the embodiments will be illustrated in the drawings, wherein same or similar reference numerals are used to indicate same or similar members or members with same or similar functions. The embodiments described herein with reference to drawings are explanatory, which are used to illustrate the present invention, but shall not be construed to limit the present invention.

In the specification, it is to be understood that terms such as “central,” “longitudinal,” “lateral,” “upper,” “lower,” “front,” “rear,” “left,” “right,” “vertical,” “horizontal,” “top,” “bottom,” “inner,” “outer,” “clockwise,” and “counterclockwise” should be construed to refer to the orientation or the positional relationship as then described or as shown in the drawings under discussion. These relative terms are for convenience of description and do not indicate or imply that the device or element referred to must have a particular orientation, or be constructed or operated in a particular orientation. In addition, terms such as “first” and “second” are used herein for purposes of description and are not intended to indicate or imply relative importance or significance.

In the description of the present disclosure, it should be understood that, unless specified or limited otherwise, the terms “mounted,” “connected,” and “coupled” are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

A search recommendation method and a search recommendation apparatus according to embodiments of the present invention will be described in the following with reference to drawings.

The present invention provides a search recommendation method, in order to resolve the difficulty of obtaining accurate information from the search results recommended because the user does not know the reasons for recommendation. The search recommendation method includes: receiving a search term; obtaining a plurality of search results related to the search term, and further obtaining at least one first recommendation result related to the search term; obtaining first relationship information between the search term and the at least one first recommendation result; and providing a search page, in which the search page includes a first display section and a second display section, the first display section displaying the plurality of search results, and the second display section displaying the at least one first recommendation result and the first relationship information.

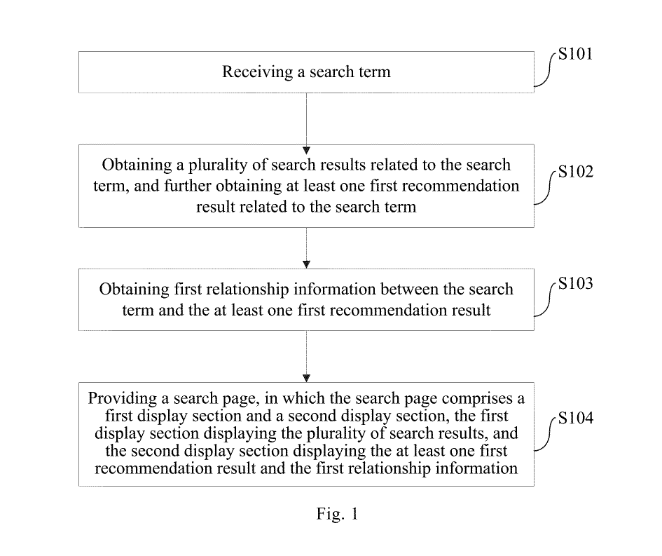

FIG. 1 is a flow chart of a search recommendation method according to an embodiment of the present invention. As shown in FIG. 1, the search recommendation method includes the following steps.

In step 101, a search term is received.

The search term may be one of characters in various languages (such as letters, pinyin, symbols and/or numbers) or the combination thereof.

In step 102, a plurality of search results related to the search term are obtained, and at least one first recommendation result related to the search term is further obtained.

The first recommendation result is a result related to the search term and screened out from Internet resources according to a certain screening rule. For instance, a search history log of the entire population of Internet users regarding the current search term is analyzed, such that top content with a high search frequency is obtained and taken as the recommendation result. In the embodiment of the present invention, at least one first recommendation result is obtained by the current or potential method for obtaining recommended search results. The present invention does not limit the method for obtaining recommended search results.

In step 103, first relationship information between the search term and the at least one first recommendation result is obtained.

In the embodiment of the present invention, the first relationship information between the search term and the at least one first recommendation result is the association relationship therebetween, which may be acquired by the search engine. The association relationship may be relationship representing the correlation, which refers to personal relationships, semantic logical relations, event relations, and a relationship between a character and other entity, and is not defined in the present invention. Specifically, for example, the search engine may conduct character recognition and semantic analysis on the search term and the at least one first recommendation result, so as to obtain the relationship information between the search term and each first recommendation result. For instance, the relationship information between “AKB48” and “Atsuko Maeda” is that “Atsuko Maeda is a leading figure in the team AKB48.”

In step 104, a search page is provided, in which the search page includes a first display section and a second display section, the first display section displaying the plurality of search results, and the second display section displaying the at least one first recommendation result and the first relationship information.

In an embodiment of the present invention, the first display section is located at a left side of the search page, and the second display section is located at a right side of the search page. In other embodiments of the present invention, the positional relationship between the first display section and the second display section may be different. For example, the first display section is located at the right side of the search page, while the second display section is located at the left side of the search page, or the other way round; or the first and second display sections are located at the upper and lower side of the search page respectively; or the second display section is presented at the front of the first display section in a manner of a pop-up window or a hover window.

In the embodiment of the present invention, the first relationship information may be displayed above or around the corresponding recommendation results.

In the embodiment of the present invention, the first relationship information may not only be presented in the form of text, but also in the form of pictures, to offer the user better browsing experience and a more intuitive understanding of the reasons for recommendation.

Since the relationship between the picture and text is difficult to recognize, the first recommendation result in the method according to the embodiment of the present invention is a picture, so as to provide the user with the relationship information between the picture recommended and the search term, to facilitate the user's understanding of the reason for recommendation. In other embodiments of the present invention, the first recommendation result may be content in another form, such as a code and a text.

By obtaining the relationship information between the search term and the recommendation result, and displaying the search result, the recommendation result, and the relationship between the recommendation result and the search term, the search recommendation method according to embodiments of the present invention can provide the user with relationship between the recommended content and the user requirement quickly and explicitly, along with more explicit reasons for recommendation, so as to stimulate the user's interest in the recommendation result and increase the attention and the click-through rate.

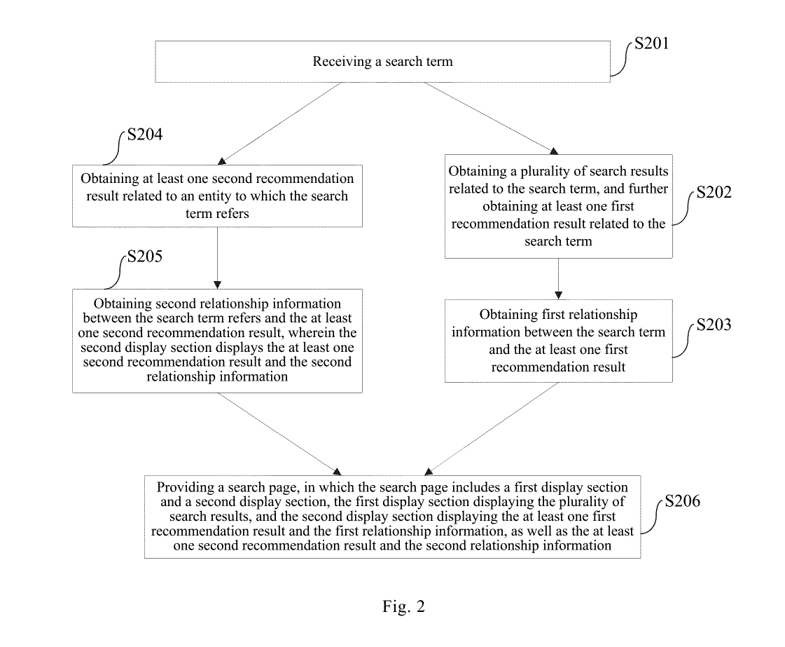

FIG. 2 is a flow chart of a search recommendation method according to an embodiment of the present invention. As shown in FIG. 2, the search recommendation method includes the following steps.

In step 201, a search term is received.

The search term may be one of characters in various languages (such as letters, pinyin, symbols and/or numbers) or the combination thereof.

In step 202, a plurality of search results related to the search term are obtained, and at least one first recommendation result related to the search term is further obtained.

The first recommendation result is a result related to the search term and screened out from Internet resources according to a certain screening rule. For instance, a search history log of the entire population of Internet users regarding the current search term is analyzed, such that top content with a high search frequency is obtained and taken as the recommendation result. In the embodiment of the present invention, at least one first recommendation result is obtained by the current or potential method for obtaining recommended search results. The present invention does not limit the method for obtaining recommended search results.

In step 203, first relationship information between the search term and the at least one first recommendation result is obtained.

In the embodiment of the present invention, the first relationship information between the search term and the at least one first recommendation result is the association relationship therebetween, which may be acquired by the search engine. The association relationship may be relationship representing the correlation, which refers to personal relationship, semantic logical relations, event relations, and relationship between characters and other entities. Specifically, for example, the search engine may conduct character recognition and semantic analysis on the search term and the at least one first recommendation result, so as to obtain the relationship information between the search term and each first recommendation result. For instance, the relationship information between “AKB48” and “Atsuko Maeda” is that “Atsuko Maeda is a leading figure in the team AKB48.”

In step 204, at least one second recommendation result related to an entity to which the search term refers is obtained.

In an embodiment of the present invention, an objective matter in the real world may be called an entity, such as a concept, a character, an object and an event, and more specifically, such as Jay Chou, the Big Bang Theory, Baidu Co., Battle of Gaoliang River, stars and animation. Each search term belongs to an entity. For example, “Miyazaki Hayao” belongs to “animation directors”; “AKB48” belongs to “Japanese idol groups.” The second recommendation result is the content corresponding to the entity to which the search term belongs and screened out from the Internet resources according to a certain screening rule. For example, regarding the search term “Miyazaki Hayao”, the second recommendation result may be relevant characters or animation works; regarding the search term“AKB48”,the second recommendation result may be relevant artists or other groups.

In step 205, second relationship information between the search term and the at least one second recommendation result is obtained, in which the second display section displays the at least one second recommendation result and the second relationship information.

In the embodiment of the present invention, the second relationship information between the search term and the at least one second recommendation result is the association relationship therebetween, which may be acquired by the search engine. The association relationship may be relationship representing the correlation, which refers to personal relationships, semantic logical relations, event relations, and a relationship between a character and other entity. Specifically, for example, the search engine may conduct character recognition and semantic analysis on the search term and the at least one second recommendation result, so as to obtain the relationship information between the search term and each second recommendation result. For instance, the relationship information between “AKB48” and the recommendation result “Kashiwagi Yuki” corresponding to the entity “relevant artists” is “one of the core members”.

In step 206, a search page is provided, in which the search page includes a first display section and a second display section, the first display section displaying the plurality of search results, and the second display section displaying the at least one first recommendation result and the first relationship information, as well as the at least one second recommendation result and the second relationship information.

In an embodiment of the present invention, the first display section is located at a left side of the search page, and the second display section is located at a right side of the search page. In other embodiments of the present invention, the positional relationship between the first display section and the second display section may be different. For example, the first display section is located at the right side of the search page, while the second display section is located at the left side of the search page, or the other way round; or the first and second display sections are located at the upper and lower side of the search page respectively; or the second display section is presented at the front of the first display section in a manner of a pop-up window or a hover window.

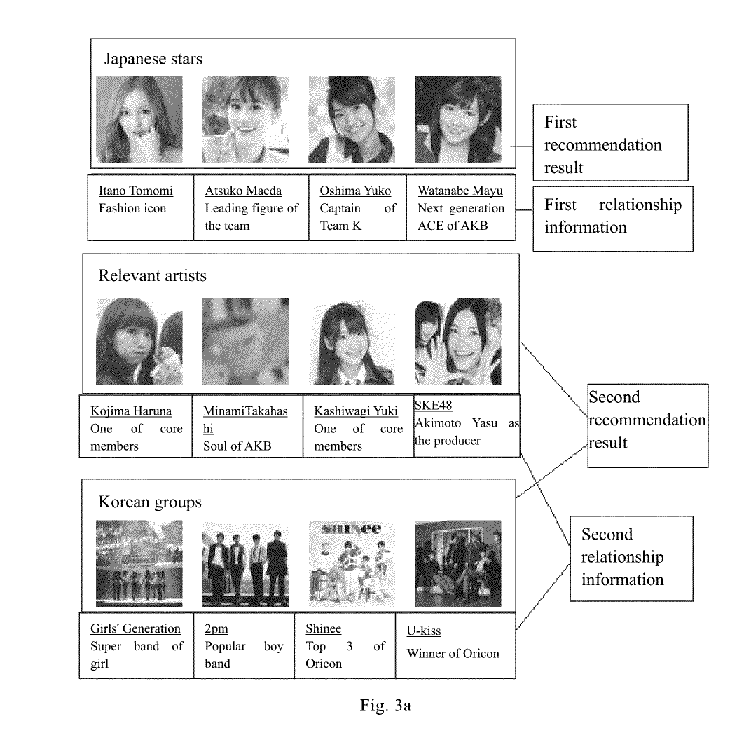

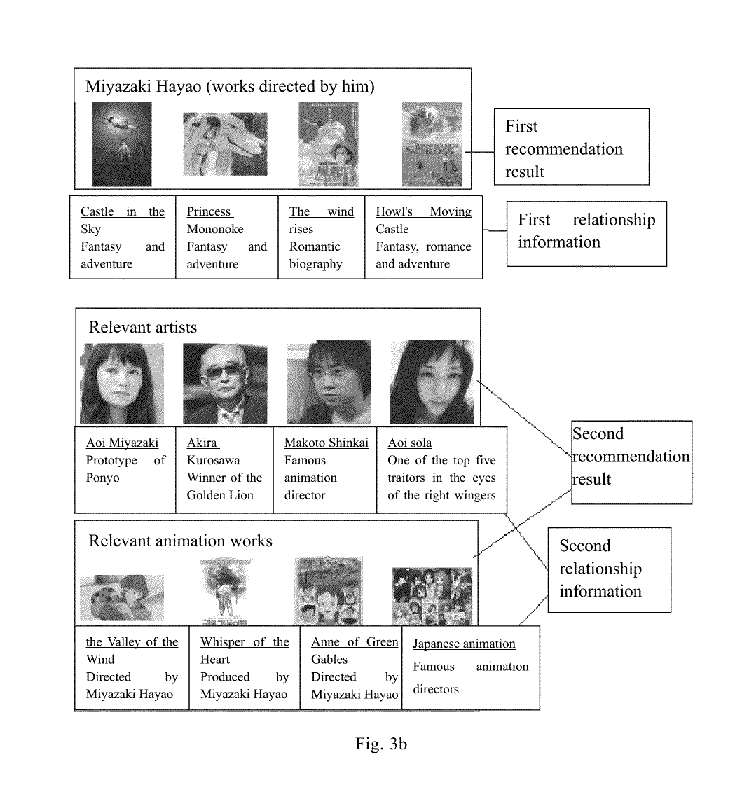

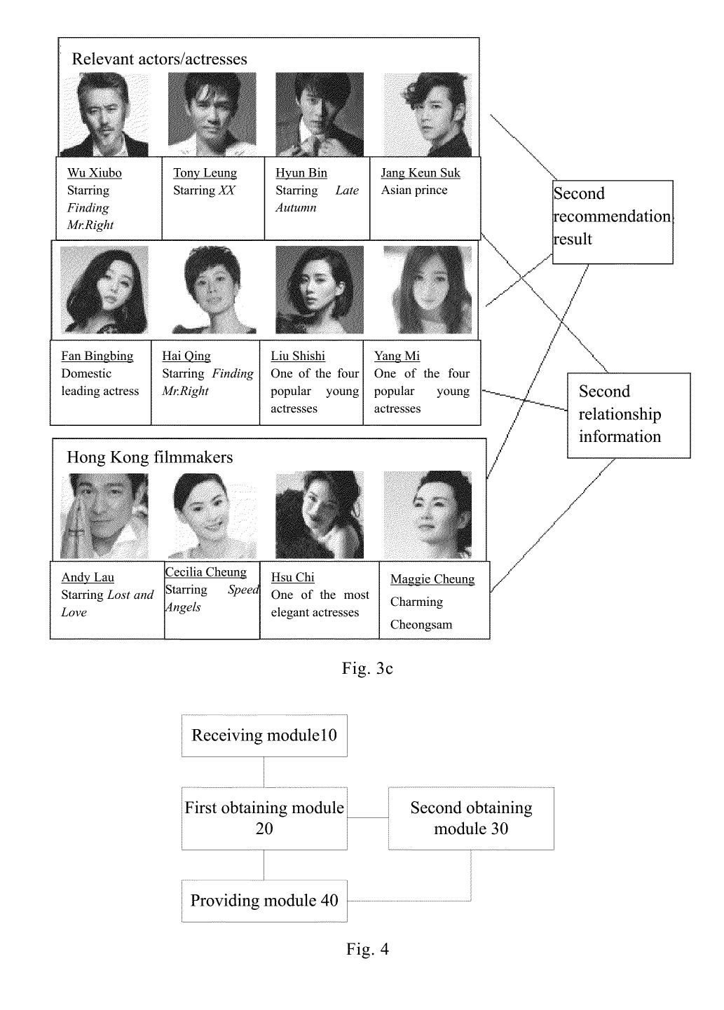

In the embodiment of the present invention, the first relationship information and the second relationship information may be displayed above or around the corresponding recommendation results. FIGS. 3a, 3b and 3c are schematic diagrams of a second display section according to an embodiment of the present invention. FIG. 3a shows the recommendation results of the search term “AKB48” and the relationship information between “AKB48” and each recommendation result; FIG. 3b shows the recommendation results of the search term “Miyazaki Hayao” and the relationship information between “Miyazaki Hayao” and each recommendation result; FIG. 3c shows the recommendation results of the search term “Tang Wei” and the relationship information between “Tang Wei” and each recommendation result. FIGS. 3a, 3b and 3c identify the relationship between the content in respective recommendation result and the search information, or introduce the recommendation results, such that the user may know the relationship between the recommendation result and the search information, along with the explicit reasons for recommendation, which helps the user better understand the association relationship between the recommendation result and the search information and inspires the interest in the recommendation results.

Since the relationship between the picture and text is difficult to recognize, the first recommendation result and the second recommendation result in the method according to the embodiment of the present invention are pictures, so as to provide the user with the relationship information between the picture recommended and the search term, to facilitate the user's understanding of the reason for recommendation. In other embodiments of the present invention, the first recommendation result and the second recommendation result may be content in another form, such as a code and a text.

In the embodiment of the present invention, the first relationship information and the second relationship information may not only be presented in the form of text, but also in the form of pictures, to offer the user better browsing experience and a more intuitive understanding of the reasons for recommendation.

The method according to the embodiment of the present invention may obtain the recommendation results according to different entities to which the search terms refer to respectively, to distinguish the content recommended, such that the user may find out items of interest rapidly and the user's searching experience may be improved.

To realize the above embodiments, the present invention further provides a search recommendation apparatus.

The search recommendation apparatus includes: a receiving module configured to receive a search term; a first obtaining module configured to obtain a plurality of search results related to the search term, and to further obtain at least one first recommendation result related to the search term; a second obtaining module configured to obtain first relationship information between the search term and the at least one first recommendation result; and a providing module configured to provide a search page, in which the search page includes a first display section and a second display section, the first display section displaying the plurality of search results, and the second display section displaying the at least one first recommendation result and the first relationship information.

FIG. 4 is a block diagram of a search recommendation apparatus according to an embodiment of the present invention.

As shown in FIG. 4, the apparatus according to the embodiment of the present invention includes a receiving module 10, a first obtaining module 20, a second obtaining module 30 and a providing module 40.

Specifically, the receiving module 10 is configured to receive a search term, in which the search term may be one of characters in various languages (such as letters, pinyin, symbols and/or numbers) or the combination thereof.

The first obtaining module 20 is configured to obtain a plurality of search results related to the search term, and to further obtain at least one first recommendation result related to the search term. The first recommendation result is a result related to the search term and screened out from Internet resources according to a certain screening rule. For instance, a search history log of the entire population of Internet users regarding the current search term is analyzed, such that top content with a high search frequency is obtained and taken as the recommendation result. In the embodiment of the present invention, the first obtaining module 20 may obtain at least one first recommendation result by the current or potential method for obtaining recommended search results. The present invention does not limit the method for obtaining recommended search results.

The second obtaining module 30 is configured to obtain first relationship information between the search term and the at least one first recommendation result. In the embodiment of the present invention, the first relationship information between the search term and the at least one first recommendation result is the association relationship therebetween, which may be acquired by the search engine. The association relationship may be relationship representing the correlation, which refers to personal relationships, semantic logical relations, event relations, and a relationship between a character and other entity, and is not defined in the present invention. Specifically, for example, the search engine may conduct character recognition and semantic analysis on the search term and the at least one first recommendation result, so as to obtain the relationship information between the search term and each first recommendation result. For instance, the relationship information between “AKB48” and “Atsuko Maeda” is that “Atsuko Maeda is a leading figure in the team AKB48.”

The providing module 40 is configured to provide a search page, in which the search page includes a first display section and a second display section, the first display section displaying the plurality of search results, and the second display section displaying the at least one first recommendation result and the first relationship information. In an embodiment of the present invention, the first display section is located at a left side of the search page, and the second display section is located at a right side of the search page. In other embodiments of the present invention, the positional relationship between the first display section and the second display section may be different. For example, the first display section is located at the right side of the search page, while the second display section is located at the left side of the search page, or the other way round; or the first and second display sections are located at the upper and lower side of the search page respectively; or the second display section is presented at the front of the first display section in a manner of a pop-up window or a hover window.

In the embodiment of the present invention, the first relationship information may be displayed above or around the corresponding recommendation results.

In the embodiment of the present invention, the first relationship information may not only be presented in the form of text, but also in the form of pictures, to offer the user better browsing experience and a more intuitive understanding of the reasons for recommendation.

By obtaining the relationship information between the search term and the recommendation result, and displaying the search result, the recommendation result, and the relationship between the recommendation result and the search term, the search recommendation apparatus according to embodiments of the present invention can provide the user with relationship between the recommended content and the user requirement quickly and explicitly, along with more explicit reasons for recommendation, so as to stimulate the user's interest in the recommendation result and increase the attention and the click-through rate.

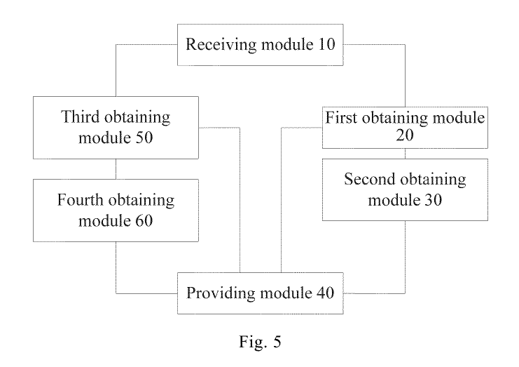

FIG. 5 is a block diagram of a search recommendation apparatus according to another embodiment of the present invention.

As shown in FIG. 5, the apparatus according to the embodiment of the present invention includes a receiving module 10, a first obtaining module 20, a second obtaining module 30, a providing module 40, a third obtaining module 50 and a fourth obtaining module 60.

Specifically, the third obtaining module 50 is configured to obtain at least one second recommendation result related to an entity to which the search term refers. In an embodiment of the present invention, an objective matter in the real world may be called an entity, such as a concept, a character, an object and an event, and more specifically, such as Jay Chou, the Big Bang Theory, Baidu Co., Battle of Gaoliang River, stars and animation. Each search term belongs to an entity. For example, “Miyazaki Hayao” belongs to “animation directors”; “AKB48” belongs to “Japanese idol groups.” The second recommendation result is the content corresponding to the entity to which the search term belongs and screened out from the Internet resources according to a certain screening rule. For example, regarding the search term “Miyazaki Hayao”, the second recommendation result may be relevant characters or animation works; regarding the search term “AKB48”, the second recommendation result may be relevant artists or other groups.

The fourth obtaining module 60 is configured to obtain second relationship information between the search term and the at least one second recommendation result, in which the second display section provided by the providing module 40 displays the at least one second recommendation result and the second relationship information. In the embodiment of the present invention, the second relationship information between the search term and the at least one second recommendation result is the association relationship therebetween, which may be acquired by the search engine. The association relationship may be relationship representing the correlation, which refers to personal relationships, semantic logical relations, event relations, and a relationship between a character and other entity. Specifically, for example, the search engine may conduct character recognition and semantic analysis on the search term and the at least one second recommendation result, so as to obtain the relationship information between the search term and each second recommendation result. For instance, the relationship information between “AKB48” and the recommendation result “Kashiwagi Yuki” corresponding to the entity “relevant artists” is “one of the core members”.

In the embodiment of the present invention, the first relationship information and the second relationship information may be displayed above or around the corresponding recommendation results. FIGS. 3a, 3b and 3c are schematic diagrams of a second display section according to an embodiment of the present invention. FIG. 3a shows the recommendation results of the search term “AKB48” and the relationship information between “AKB48” and each recommendation result; FIG. 3b shows the recommendation results of the search term “Miyazaki Hayao” and the relationship information between “Miyazaki Hayao” and each recommendation result; FIG. 3c shows the recommendation results of the search term “Tang Wei” and the relationship information between “Tang Wei” and each recommendation result. FIGS. 3a, 3b and 3c identify the relationship between the content in respective recommendation result and the search information, or introduce the recommendation results, such that the user may know the relationship between the recommendation result and the search information, along with the explicit reasons for recommendation, which helps the user better understand the association relationship between the recommendation result and the search information and inspires the interest in the recommendation results.

In the embodiment of the present invention, the first relationship information and the second relationship information may not only be presented in the form of text, but also in the form of pictures, to offer the user better browsing experience and a more intuitive understanding of the reasons for recommendation.

The apparatus according to the embodiment of the present invention can provide the user with relationship between the recommended content and the user requirement quickly and explicitly, along with more explicit reasons for recommendation, so as to stimulate the user's interest in the recommendation result and increase the attention and the click-through rate.

Since the relationship between the picture and text is difficult to recognize, the first recommendation result in the method according to the embodiment of the present invention is a picture, so as to provide the user with the relationship information between the picture recommended and the search term, to facilitate the user's understanding of the reason for recommendation. In other embodiments of the present invention, the first recommendation result may be content in another form, such as a code and a text.

To realize the above embodiments, the present invention further provides a storage medium for storing an application program which is configured to execute the search recommendation method according to any embodiment of the present invention.

Any process or method described in a flow chart or described herein in other ways may be understood to include one or more modules, segments or portions of codes of executable instructions for achieving specific logical functions or steps in the process, and the scope of a preferred embodiment of the present invention includes other implementations, not necessarily in the sequence shown or discussed here, but probably including the almost same or reverse sequence of the involved functions, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present invention may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the present invention may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The above-mentioned storage medium may be, but is not limited to, read-only memories, magnetic disks, or optical disks.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A search recommendation method, comprising:
receiving a search term;
obtaining a plurality of search results related to the search term, and further obtaining at least one first recommendation result related to the search term;
obtaining first relationship information between the search term and the at least one first recommendation result; and
providing a search page, wherein the search page comprises a first display section and a second display section, the first display section displaying the plurality of search results, and the second display section displaying the at least one first recommendation result and the first relationship information.

2. The method according to claim 1, wherein the first display section is located at a left side of the search page, and the second display section is located at a right side of the search page.

3. The method according to claim 1, further comprising:
obtaining at least one second recommendation result related to an entity to which the search term refers; and
obtaining second relationship information between the search term and the at least one second recommendation result, wherein the second display section displays the at least one second recommendation result and the second relationship information.

4. The method according to claim 1, wherein the at least one first recommendation result is a picture, and the first relationship information is displayed on the picture.

5. The method according to claim 1, wherein the first relationship information is acquired by a search engine.

6. A search recommendation apparatus, comprising:
a processor; and
a memory for storing instructions executable by the processor,
wherein the processor is configured to:
receive a search term;
obtain a plurality of search results related to the search term, and further obtain at least one first recommendation result related to the search term;
obtain first relationship information between the search term and the at least one first recommendation result; and
provide a search page, wherein the search page comprises a first display section and a second display section, the first display section displaying the plurality of search results, and the second display section displaying the at least one first recommendation result and the first relationship information.

7. The apparatus according to claim 6, wherein the first display section is located at a left side of the search page, and the second display section is located at a right side of the search page.

8. The apparatus according to claim 6, wherein the processor is further configured to:
obtain at least one second recommendation result related to an entity to which the search term refers; and
obtain second relationship information between the entity and the at least one second recommendation result, wherein the second display section provided by the providing module displays the at least one second recommendation result and the second relationship information.

9. The apparatus according to claim 6, wherein the at least one first recommendation result is a picture, and the first relationship information is displayed on the picture.

10. The apparatus according to claim 6, wherein the first relationship information is acquired by a search engine.

11. A storage medium for storing an application program which is configured to execute the search recommendation method, wherein the method comprises:
receiving a search term;
obtaining a plurality of search results related to the search term, and further obtaining at least one first recommendation result related to the search term;
obtaining first relationship information between the search term and the at least one first recommendation result; and
providing a search page, wherein the search page comprises a first display section and a second display section, the first display section displaying the plurality of search results, and the second display section displaying the at least one first recommendation result and the first relationship information.

12. The method according to claim 2, further comprising:
obtaining at least one second recommendation result related to an entity to which the search term refers; and
obtaining second relationship information between the search term and the at least one second recommendation result, wherein the second display section displays the at least one second recommendation result and the second relationship information.

13. The method according to claim 2, wherein the at least one first recommendation result is a picture, and the first relationship information is displayed on the picture.

14. The method according to claim 3, wherein the at least one first recommendation result is a picture, and the first relationship information is displayed on the picture.

15. The method according to claim 3, wherein the at least one second recommendation result is a picture, and the second relationship information is displayed on the picture.

16. The method according to claim 2, wherein the first relationship information is acquired by a search engine.

17. The method according to claim 3, wherein the first relationship information is acquired by a search engine.

18. The method according to claim 3, wherein the second relationship information is acquired by a search engine.

19. The method according to claim 4, wherein the first relationship information is acquired by a search engine.
